(19) United States
(12) Patent Application Publication
(10) Pub. No.: US 2026/0124743 A1
(43) Pub. Date: May 7, 2026

(54) ORBIT ACTUATOR

(71) Applicant: C&P R&D Company, Kennesaw, GA (US)

(72) Inventors: Bryce Cianciotto, Dahlonega, GA (US); Nikhil Pai, Kennesaw, GA (US)

(21) Appl. No.: 19/350,319

(22) Filed: Oct. 6, 2025

Related U.S. Application Data
(60) Provisional application No. 63/703,735, filed on Oct. 4, 2024.

(51) Int. Cl. B25J 9/12; B25J 17/02

(52) U.S. Cl. CPC B25J 9/126; B25J 17/0283

(57) ABSTRACT

This application relates to an actuator that can include an end effector, a chassis, and a spherical joint positioned between the end effector and the chassis. The spherical joint can include an upper hemisphere that forms an upper half of the spherical joint. The spherical joint can include a lower hemisphere that forms a lower half of the spherical joint. The upper hemisphere and the lower hemisphere can lie concentrically within a common spherical plane.

### CROSS-REFERENCE TO RELATED APPLICATIONS

This application claims priority from U.S. Provisional Ser. No. 63/703,735, filed on Oct. 4, 2024. U.S. Provisional Ser. No. 63/703,735 is incorporated herein by reference.

### TECHNICAL FIELD

The present invention relates generally to systems and mechanisms for performing complex motion and, more particularly, but not by way of limitation, to a robotic actuator capable of multi-axis actuation.

### BACKGROUND OF THE INVENTION

In engineering, existing systems that require complex motion/multi-axis actuation achieve that motion by placing motors at each joint in the system. This solution is not limited to robotic arms/6-axis robots. Placing motors at each joint in the system is used across every application that requires multi-axis motion. Robotic arms are the most common example of this. Typically, multi-axis systems operate by placing motors at every joint; however, this design creates several challenges. For example, since the weight of each motor in a traditional multi-axis system needs to be sufficiently supported, both to minimize vibrations across the system and to maximize the system's reliability and strength, the structure required to accommodate these designs tends to be bulky. Additionally, when the traditional multi-axis systems move, each motor is required to move in a specific way relative to every other motor. Since each motor is offset from one another and each of their axes of motion lies on a different plane and in a different direction, it makes the math/kinematics and the programming/control of the traditional multi-axis systems a challenge.

Additionally, due to the placement of the motors described above, wiring the traditional multi-axis systems is also problematic. The wires that go to various components of the traditional multi-axis system such as, for example, motors, sensors, and other auxiliary components need to route through the multi-axis system without impeding their continuous motion or without severing their wires via, for example, overextension in any direction. As a result, traditional multi-axis systems are either more reliable with limited mobility or a less reliable with better mobility. However, in both cases, wiring the traditional multi-axis system is perpetually problematic. Therefore, there is a need for a system and mechanism that can achieve multi-axis motion without using a series of single-axis joints.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A is a side perspective view of an exemplary orbit actuator;

FIG. 1B is a side perspective view of an exemplary orbit actuator illustrating a plurality of axis around which the exemplary orbit actuator rotates;

FIG. 1C is a top view of an end effector;

FIG. 2A is a partially sectioned side view illustrating internal components of the exemplary orbit actuator of FIG. 1A;

FIG. 2B is a partially sectioned side view of the exemplary orbit actuator of FIG. 1A illustrating a plurality of gearboxes mounted to a plurality of motors;

FIG. 3 is a partially sectioned side view illustrating internal components of an alternate embodiment of an orbit actuator;

FIG. 4 is a system illustrating a plurality of orbit actuators linked together;

FIG. 5A is a partially sectioned side view illustrating internal components of an alternate embodiment of an orbit actuator;

FIG. 5B is a partially sectioned side view illustrating internal components of an alternate embodiment of an orbit actuator;

FIG. 6A is a partially sectioned side view illustrating internal components of an alternate embodiment of an orbit actuator;

FIG. 6B is a partially sectioned side view illustrating internal components of an alternate embodiment of an orbit actuator;

FIG. 7A is a partially sectioned side view illustrating internal components of an alternate embodiment of an orbit actuator;

FIG. 7B is a partially sectioned side view illustrating internal components of an alternate embodiment of an orbit actuator;

FIG. 7C is a flow diagram of an illustrative process for rotating the exemplary orbit actuator along a first axis;

FIG. 7D is a flow diagram of an illustrative process for rotating the exemplary orbit actuator along a second axis;

FIG. 7E is a flow diagram of an illustrative process for rotating the exemplary orbit actuator along a third axis; and

FIG. 8 illustrates a computing environment for controlling the exemplary orbit actuators disclosed above in FIGS. 1A-7B.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, as used herein, the term “coupled” may include direct or indirect coupling by any means, including moving and/or non-moving mechanical connections.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Exemplary embodiments disclose systems, methods and apparatuses for performing complex motion, and more specifically to an orbit actuator capable of multi-axis actuation. In most multi-axis systems, motors are chained together to move along each axis of rotation such as, for example, in a robot arm in a manufacturing facility. The exemplary orbit actuator can combine at least three axes of motion into one three-degrees-of-freedom (3 DOF) spherical joint. The exemplary orbit actuator is an innovative solution designed to address the complexities and inefficiencies associated with traditional multi-axis systems. Traditional multi-axis systems typically place motors at each joint, leading to several issues such as, for example, bulkiness, complex kinematics, problematic wiring, and high research and development costs. The exemplary orbit actuator overcomes these challenges by integrating a spherical joint that mimics a natural motion of, for example, a ball-and-socket joint, providing 3 DOF motion in a compact and efficient design.

When designing multi-axis systems, several factors must be accounted for such as, for example, load, orientation, speed, travel, precision, environment, duty cycle (LOSTPED), or the like. Load refers to forces applied to a system. Orientation refers to a position of an actuator. Speed refers to velocity and acceleration of the system when the system moves. Travel refers to a distance or range of motion of the system. Precision refers to accuracy or repeatability of the travel or positioning of the system. Environment refers to surrounding conditions that the system operates in. Duty cycle refers to how long the system runs compared to the system's rest time. The exemplary orbit actuator optimizes the LOSTPED of each motor in its multi-axis system compared to traditional multi-axis systems.

With regard to load, traditional systems require each motor to support the weight of subsequent motors and components, leading to increased load and bulkiness. The exemplary orbit actuator minimizes the load across each motor. The motors in the exemplary orbit actuator are not required to move each other to change the position and rotation of the actuators'end effector. With regard to orientation, traditional systems have a complex orientation due to motors being offset and on different planes. The exemplary orbit actuator simplifies the orientation by mounting the motors concentrically on top of one another, aligning their axes of rotation along a single axis. With regard to speed, traditional systems are limited in speed due to their need to support the heavy weight of the system. The exemplary orbit actuator maximizes speed by minimizing the mass required for multi-axis motion. The motors of the exemplary orbit actuator are not required to be throttled, allowing for higher operational speeds.

With regard to travel, traditional systems require significant travel distance between motors to achieve multi-axis motion. The exemplary orbit actuator minimizes travel distance as all the motors are housed within a single chassis. This design eliminates a need for relative movement between the motors. With regard to precision, traditional systems are affected by deflection and dynamic loads. The exemplary orbit actuator can maximize precision by fixing the motors in place, thus eliminating deflection and dynamic loads that would otherwise impact precision. With regard to environment, traditional systems are susceptible to environmental hazards that can affect performance of the motors. The exemplary orbit actuator can house the motors within a durable cylindrical chassis, protecting the motors from environmental hazards such as, for example, water, dust, or the like. With regard to duty cycle, the exemplary orbit actuator can be optimized for longer duty cycles because the motors do not need to work as hard to compensate for suboptimal loads, orientations, speeds, travel, and precision prevalent in traditional multi-axis systems, thus enabling the motors to work longer with fewer breaks.

The exemplary orbit actuator represents significant advancements in multi-axis motion systems, offering a compact, efficient, and versatile solution that addresses key challenges of traditional designs. The exemplary orbit actuator's innovative spherical joint and integrated through-hole feature ensure precise, reliable, and unobstructed multi-axis motion, making it suitable for a wide range of applications in, for example, robotics, manufacturing, medical devices, or the like.

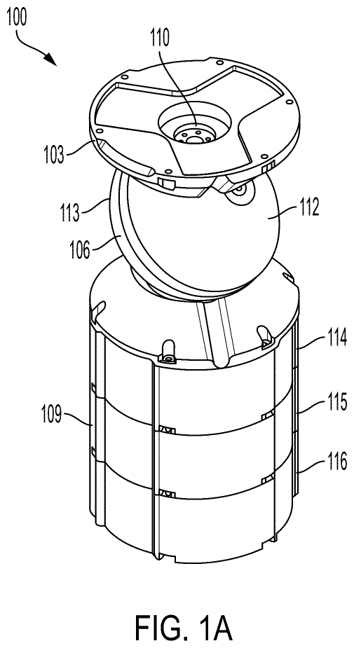

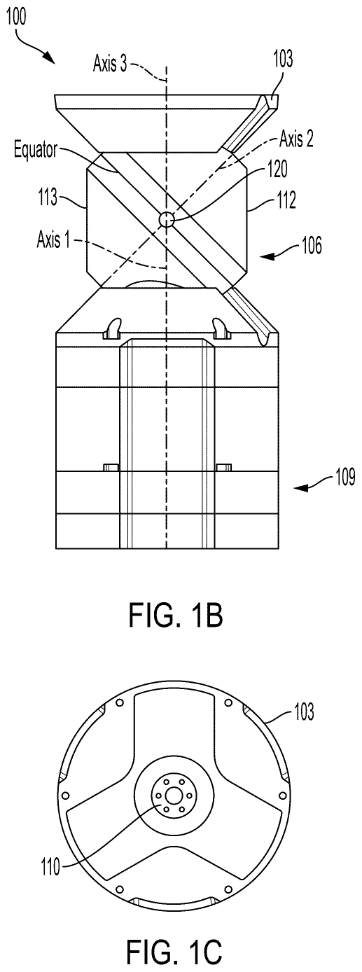

FIG. 1A is a side perspective view of an exemplary orbit actuator 100. FIG. 1B is a side view of the exemplary orbit actuator 100 illustrating a plurality of axis around which the exemplary orbit actuator 100 rotates. Referring now to FIGS. 1A-1B, in a typical embodiment, the orbit actuator 100 includes an end effector 103, a spherical joint 106, a chassis 109, and a through-aperture 110. The end effector 103 serves as a functional tip of the orbit actuator 100. The end effector 103 may be attached to an end of the orbit actuator 100 and may interact with the environment. The end effector 103 may be of various types depending on the desired task of the orbit actuator 100. For example, the end effector 103 may be, for example, a gripper, a cutting tool, a welding torch, a sensor, a vacuum gripper, or any other specialized tool for the desired task of the orbit actuator 100.

In a typical embodiment, the end effector 103 may be attached to the spherical joint 106. The spherical joint 106 may be positioned between the end effector 103 and the chassis 109. The spherical joint 106 enables the orbital actuator 100 to perform precise and complex motion, providing a compact and efficient resource of achieving 3DOF motion. In a typical embodiment, the spherical joint 106 is configured to mimic a natural motion of, for example, a ball-and-socket joint, similar to a human shoulder, enabling the spherical joint 106 to perform a wide range of movements in multiple directions. The design of the exemplary orbit actuator 100 addresses several issues commonly found in traditional multi-axis systems. For example, by combining plurality of axes of motion into a single joint, the spherical joint 106 reduces bulkiness typically associated with traditional multi-axis systems. In a typical embodiment, the spherical joint 106 combines at least three axes of motion into a single joint. The spherical joint 106 is configured to simplify the mathematical and control complexities involved in multi-axis motion.

In a typical embodiment, the at least three axes of motion can be achieved via an upper hemisphere 112, a lower hemisphere 113, and the end effector 103. The lower hemisphere 113 is configured to rotate within a first plane and provide a first axis of motion. The upper hemisphere 112 is configured to rotate within a second plane and provide a second axis of motion. The end effector 103 provides a third axis of motion. In a typical embodiment, each of the upper hemisphere 112 and the lower hemisphere 113 lies concentrically within a common spherical plane, and the axes of motion of the upper hemisphere 112, the lower hemisphere 113, and the end effector 103 all pierce an origin point 120 of the spherical plane. An equator which is, for example, a two-dimensional plane that divides the upper hemisphere 112 and the lower hemisphere 113, lies at approximately a 45° angle relative to Axis 1. In a typical embodiment, the lower hemisphere 113 rotates around Axis 1 while the upper hemisphere 112 rotates around Axis 2. The end effector 103 rotates around Axis 3. Axis 1 is an axis that lies along a longitudinal axis of the exemplary actuator 100. Axis 2 is an axis that pierces the origin point 120 of the spherical plane and lies perpendicular to the equator. Axis 3 is an axis that lies at approximately a 45° angle relative to axis 2 and pierces the origin point 120 of the spherical plane.

The chassis 109 may be attached to the spherical joint 106 opposite the end effector 103. The chassis 109 includes a plurality of cylindrical housings 114, 115, 116 stacked concentrically atop one other. For illustrative purposes, the chassis 109 is illustrated as having three cylindrical housings 114, 115, 116; however, in other embodiments, the chassis 109 can have any number of cylindrical housings as dictated by design requirements. Each of the cylindrical housings 114, 115, 116 may include, for example, a hollow shaft motor (not illustrated). The hollow shaft motor may be a type of electric motor that features a hollow center through its axis. This design enables various items such as, for example, cables, hosing, piping, or other component to pass through the motors without obstruction. Each of the hollow shaft motors can include a shaft mounted on a rotor. Each of the shafts can nest concentrically within one another, running up and out the chassis, where the shafts mesh with the spherical joint 106.

The orbit actuator 100 also includes the through-aperture 110. In a typical embodiment, the through-aperture 110 includes a cavity that runs through a center of one of a shaft (not illustrated) of the chassis 109, the origin point 120 of the spherical joint 106, and the end effector 103. The through-aperture 110 facilitates the integration of the orbit actuator 100 with other mechanical or electrical systems. The through-aperture 110 allows, for example, wires, cable, tubing, or the like to route through the entire orbit actuator 100 without impeding the orbit actuator's 100 continuous motion. Additionally, sensors, cameras, or other end effector components that require power or data connections can be easily connected through the through-aperture 110 without impeding the orbit actuator's 100 multi-axis motion.

FIG. 1C is a top view of the end effector 103 of FIG. 1A illustrating the through-aperture 110. For illustrative purposes, FIG. 1C will be described herein relative to FIGS. 1A-1B. In a typical embodiment, the through-aperture 110 allows, for example, wires, cable, tubing, or the like to route through the entire orbit actuator 100 without impeding the orbit actuator's 100 continuous multi-axis motion. Additionally, sensors, cameras, or other end effector components that require power or data connections can be easily connected through the through-aperture 110 without impeding the orbit actuator's 100 multi-axis motion.

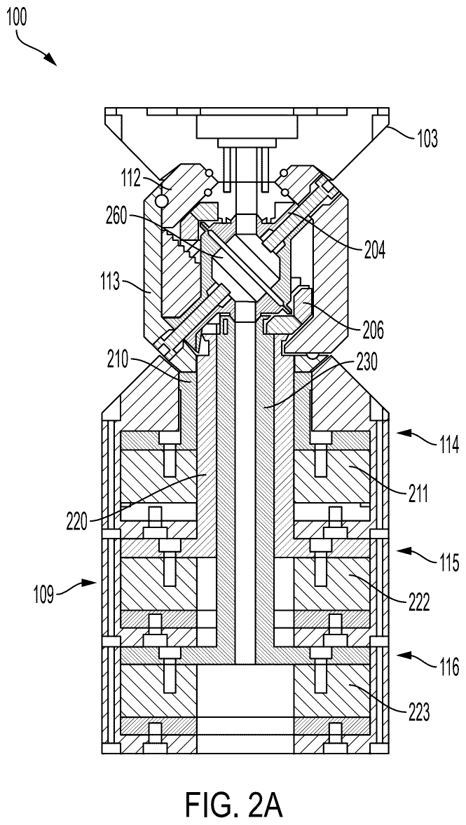

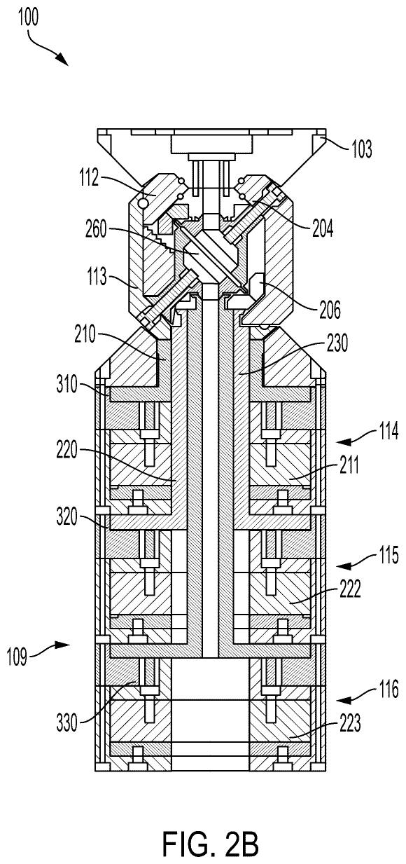

FIG. 2A is a partially sectioned side view illustrating internal components of the exemplary orbit actuator 100 of FIG. 1A. For illustrative purposes, FIG. 2A will be described herein relative to 1A-1C. In a typical embodiment, the orbit actuator 100 includes various components that allow the orbit actuator 100 to achieve multi-axis motion. In a typical embodiment, the orbit actuator 100 includes the end effector 103, an end effector gear 204, a double-sided ring gear 206, the upper hemisphere 112, and the lower hemisphere 113. The orbit actuator 100 further includes a hollow-thrust-bearing-nut 260, a plurality of shafts and a plurality of motors. In a typical embodiment, the plurality of shafts includes a first shaft 210, a second shaft 220, and a third shaft 230 while the plurality of motors includes a first motor 211, a second motor 222, and a third motor 223. For illustrative purposes, the orbit actuator 100 is described as having three shafts and three motors; however, in other embodiments, any number of shafts and motors may be used to operate the orbit actuator 100 as dictated by design requirements.

The first motor 211, the second motor 222, and the third motor 223 are positioned within the chassis 109. The chassis 109 includes the plurality of cylindrical housings 114, 115, 116 stacked concentrically atop one other. For illustrative purposes, the orbit actuator 100 is described as having three cylindrical housings 114, 115, 116; however, in other embodiments, any number of cylindrical housings may be used to operate the orbit actuator 100 as dictated by design requirements. Each cylindrical housing 114, 115, 116 can accommodate at least one motor. For example, in the embodiment illustrated in FIG. 2A, the first motor 211 is positioned within the first housing 114, the second motor 222 is positioned within the second housing 115 and the third motor 223 is positioned within the third housing 116.

In a typical embodiment, the spherical joint 106 is made of the upper hemisphere 112 and the lower hemisphere 113. For example, the upper hemisphere 112 forms an upper half of the spherical joint 106 while the lower hemisphere 113 forms the lower half of spherical joint 106. In a typical embodiment, each of the upper hemisphere 112 and the lower hemisphere 113 lies concentrically within the same spherical plane and the axes of motion of the upper hemisphere 112, the lower hemisphere 113, and the end effector 103 all pierce the origin point 120 of the spherical plane.

In a typical embodiment, the at least three axes of motion of the orbit actuator 100 is achieved via the upper hemisphere 112, the lower hemisphere 113, and the end effector 103. The lower hemisphere 113 is configured to rotate within the first plane and provide the first axis of motion. In a typical embodiment, the lower hemisphere 113 rotates around Axis 1. The upper hemisphere 112 is configured to rotate within the second plane and provide the second axis of motion. In a typical embodiment, the upper hemisphere 112 rotates around Axis 2. The end effector 103 rotates around Axis 3. The equator which is, for example, a two-dimensional plane that divides the upper hemisphere 112 and the lower hemisphere 113, lies at approximately a 45° angle relative to Axis 1. Axis 2 is an axis that pierces an origin point of the spherical plane and lies perpendicular to the equator. Axis 3 is an axis that lies at approximately a 45° angle relative to axis 2 and pierces the origin point 120 of the spherical plane. In a typical embodiment, the upper hemisphere 112 is connected to the lower hemisphere 113 via, for example, a hollow-thrust-bearing-nut (HTBN) 260. HTBN 260 creates a cavity in the center of the spherical joint 106 to continue the through-aperture 110 to route through the orbit actuator 100. For illustrative purposes, the HTBN 260 is described as a connector for the upper hemisphere 112 and the lower hemisphere 113; however, in other embodiments, the upper hemisphere 112 may be connected to the lower hemisphere 113 via other fasteners that are hollow and have thrust-bearing capabilities.

The various components of the orbit actuator 100 disclosed above are part of a kinetic chain that corresponds to an axis of motion of the orbit actuator 100. For example, a first kinetic chain includes the first shaft 210, the first motor 211, and the lower hemisphere 113. The first kinetic chain enables the orbit actuator 100 to move in the first axis of motion. The first motor 211 may be operatively connected to the lower hemisphere 113 via the first shaft 210. The first shaft 210 may be designed to nest concentrically within the other shafts of the orbit actuator 100, allowing the first shaft 210 to run up and out of the chassis 109 without interference. The lower hemisphere 113 may be spun by the first motor 211 and rotates around the first axis of motion (i.e., Axis 1).

A second kinetic chain includes the second shaft 220, the second motor 222, and the upper hemisphere 112. The second kinetic chain enables the orbit actuator 100 to move in the second axis of motion. The second motor 222 may be operatively connected to the upper hemisphere 112 via the second shaft 220. In a typical embodiment, the second shaft 220 can function as, for example, a pinion and the upper hemisphere 112 can function as, for example, a bevel/ring gear. This design utilizing the pinion and the bevel/ring gear allows the second motor 222 to rotate the upper hemisphere 112 via the second shaft 220. The upper hemisphere 112 rotates around the second axis of motion (i.e., Axis 2).

A third kinetic chain includes the third shaft 230, the third motor 223, the double-sided ring gear 206, the end effector gear 204, and the end effector 103. The third kinetic chain enables the orbit actuator 100 to move in the third axis of motion. The third motor 223 may be operatively connected to the end effector 103 via the third shaft 230. The third shaft 230 can function as, for example, a pinion that can be connected to the double-sided ring gear 206 inside the spherical joint 106. The end effector 103 may be connected to the double-sided ring gear 206 and may also function as a pinion. This pinion-gear-pinion design allows the third shaft 230 to rotate the end effector 103. The end effector 103 rotates around the third axis of motion (i.e., Axis 3).

The orbit actuator 100 may be optimized to reduce orthogonality. Orthogonality in multi-axis systems refers to an arrangement where each axis of motion is perpendicular to the others. While this configuration is common in traditional multi-axis systems, it presents several disadvantages such as, for example, complexity in design and manufacturing, bulkiness, weight, kinematic complexity, cable management issues, and dynamic loading and deflection. According to exemplary embodiments, the first, second and third motors 211, 222, 223 of the orbit actuator 100 are positioned concentrically atop one another. As such, the axes of rotation of each of the first, second and third motors 211, 222, 223 aligns along a single axis. Each of these axes converge on a single point a small distance away from the first, second and third motors 211, 222, 223. At this point, the axes diverge to form a 3 DOF joint capable of producing motion along the spherical plane. As a result, each of the first, second and third motors 211, 222, 223 in the orbit actuator 100 does not need to be orthogonal to one another to achieve multi-axis motion.

In traditional multi-axis systems, each consecutive motor along each axis of motion is weaker than the next. This is because the motors toward the base are required to accommodate the weight of the rest of the system. As a result, each motor in the chain gets lighter and weaker. According to exemplary embodiments, the first, second and third motors 211, 222, 223 of the orbit actuator 100 are identical. For example, the first, second and third motors 211, 222, 223 of the orbit actuator 100 are capable of producing the same amount of torque. By utilizing identical motors, the homogeneity of the system is maximized making it easier to support and use the orbit actuator 100. Additionally, since the first, second and third motors 211, 222, 223 of the orbit actuator 100 do not need to move relative to one another to achieve multi-axis motion, the dynamic loads that would otherwise plague traditional multi-axis systems are minimized.

FIG. 2B is a partially sectioned side view of the exemplary orbit actuator of FIG. 1A illustrating a plurality of gearboxes positioned within the orbit actuator 100. For illustrative purposes, FIG. 2B will be described herein relative to 1A-2A. In a typical embodiment, the orbit actuator 100 may include a first gearbox 310, a second gearbox 320, and a third gearbox 330. In a typical embodiment, the first gearbox 310 may be mounted on the first motor 211 and can modify the torque of the first kinetic chain. A second gearbox 320 may be mounted on the second motor 222 and can modify the torque of the second kinetic chain. A third gearbox 330 may be mounted on the third motor 233 and can modify the torque of the third kinetic chain. The first, second, and third gearboxes 310, 320, 330 of the orbit actuator 100 may be housed in the chassis 109 in the same cylindrical housing as their respective motor.

In a typical embodiment, the first, second, and third gearboxes 310, 320, 330 of the orbit actuator 100 may be planetary gearboxes that may include, for example, a central sun gear, multiple planet gears, and an outer ring gear. In other embodiments, strain wave, cycloidal, or other gearboxes may be used as dictated by design requirements. According to exemplary embodiments, the first, second, and third gearboxes 310, 320, 330 are swappable and removable in applications where more torque or more rpm is required. Torque produced by the first, second, and third motors 211, 222, 233 is transmitted to the first, second, and third gearboxes 310, 320, 330 resulting in rotation of, for example, the central sun gear, multiple planet gears, and the outer ring gear. The orbit actuator 100 may include other mechanical components that are capable of transmitting torque and power transmission in addition to the planetary gearboxes.

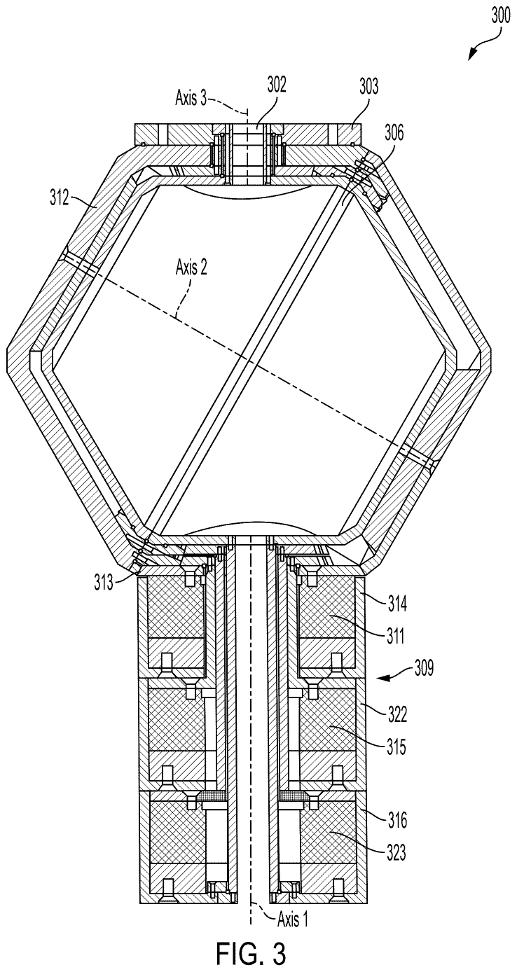

FIG. 3 is a partially sectioned side view illustrating internal components of an alternate embodiment of an orbit actuator 300. For illustrative purposes, FIG. 3 will be described herein relative to FIGS. 1A-2B. In a typical embodiment, the orbit actuator 300 includes a spherical joint 306, a chassis 309, and a through-aperture 302. The chassis 309 includes a plurality of cylindrical housings 314, 315, 316 stacked concentrically atop one other. For illustrative purposes, the chassis 309 is illustrated as having three cylindrical housings 314, 315, 316; however, in other embodiments, the chassis 309 can have any number of cylindrical housings as dictated by design requirements. Each cylindrical housing 314, 315, 316 can accommodate at least one motor. For example, a first motor 311 is positioned within a first housing 314, a second motor 322 is positioned within a second housing 315, and a third motor 323 is positioned within a third housing 316. According to exemplary embodiments, the first, second and third motors 311, 322, 323 of the orbit actuator 300 are positioned concentrically atop one another. In a typical embodiment, the first, second and third motors 311, 322, 323 are hollow shaft motors enabling various items such as, for example, cables, hosing, piping, or other component to pass through the motor without obstruction.

In a typical embodiment, the spherical joint 306 is made of an upper hemisphere 312 and a lower hemisphere 313. For example, the upper hemisphere 312 forms an upper half of the spherical joint 306 while the lower hemisphere 313 forms the lower half of spherical joint 306. In a typical embodiment, the spherical joint 306 is configured to perform a wide range of movements in multiple directions. The design of the exemplary orbit actuator 300 addresses several issues commonly found in traditional multi-axis systems. For example, by combining a plurality of axes of motion into a single joint, the spherical joint 306 reduces bulkiness typically associated with traditional multi-axis systems. In a typical embodiment, the first motor 311 rotates the lower hemisphere 313 about Axis 1. The second motor 322 rotates the upper hemisphere 312 about Axis 2 while the third motor 323 rotates an end effector 303 about Axis 3. The orbit actuator 300 illustrated in FIG. 3 is similar to the orbit actuator 100 of FIGS. 2A-2B with the exception that angles of the axis of motion are different compared to the angles of the axis of motion of the embodiments described in FIGS. 2A-2B. In a typical embodiment, Axis 2 lies at approximately a 60° angle relative to Axis 1 and Axis 3 lies at approximately a 60° angle relative to Axis 2. As a result, the resulting geometry is more hexagonal in nature but functionally remains the same. In the embodiment of FIG. 3, the orbit actuator 300 has more than a hemispherical work envelope as compared to the work envelope disclosed in FIGS. 2A-2B. Embodiments disclosed in FIG. 3 are particularly useful in applications where additional range of motion is critical.

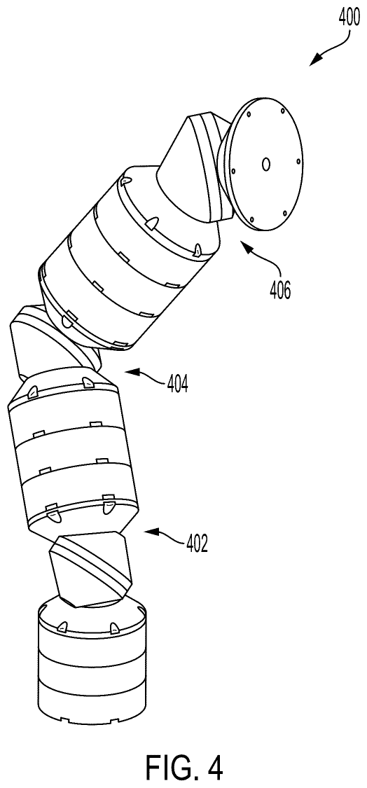

FIG. 4 is a system 400 illustrating a plurality of orbit actuators linked together. For illustrative purposes, FIG. 4 will be described herein relative to 1A-2B. In a typical embodiment, the system 400 illustrates a first orbit actuator 402, a second orbit actuator 404, and a third orbit actuator 406 linked together to achieve complex motion in larger systems. The first orbit actuator 402, the second orbit actuator 404, and the third orbit actuator 406 are similar to the orbit actuator 100 described in FIGS. 1A-2B. For illustrative purposes, the system 400 is described as having three orbit actuators 402, 404, 406 linked together; however, in other embodiments, any number of orbit actuators may be linked together to achieve complex motion as dictated by design requirements.

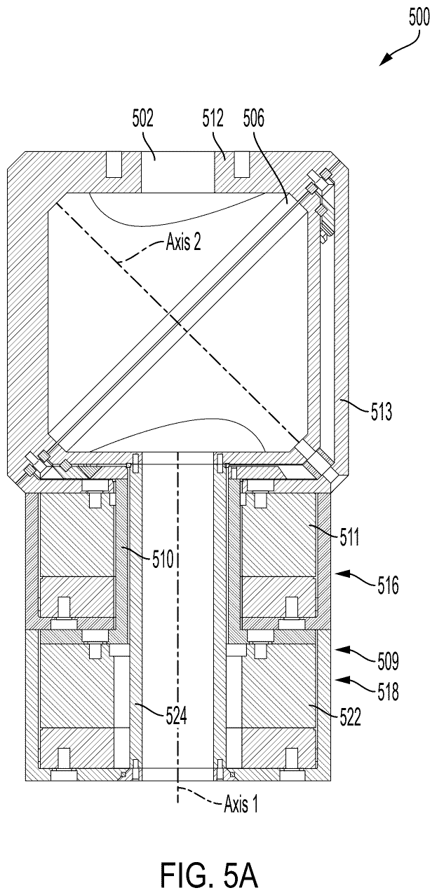

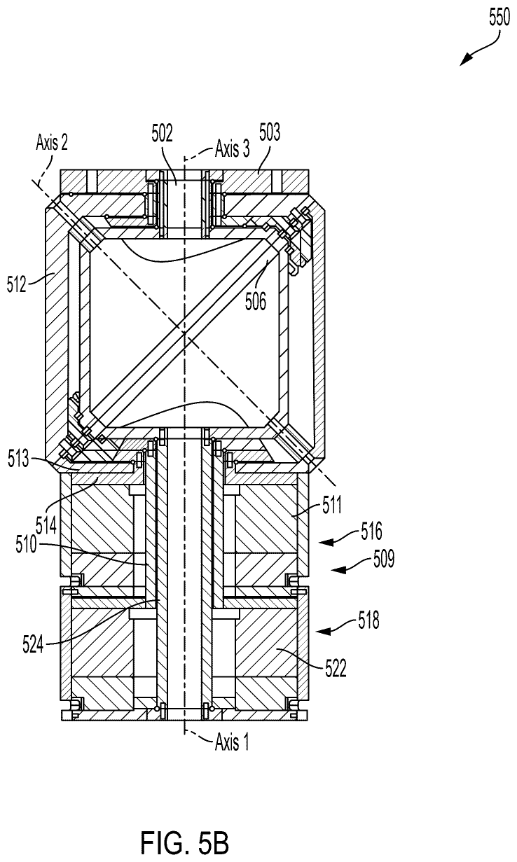

FIG. 5A is a partially sectioned side view illustrating internal components of an alternate embodiment of an orbit actuator 500. In a typical embodiment, the orbit actuator 500 includes a spherical joint 506, a chassis 509, and a through-aperture 502. The chassis 509 includes a plurality of cylindrical housings 516, 518 stacked concentrically atop one other. For illustrative purposes, the chassis 509 is illustrated as having two cylindrical housings 516, 518; however, in other embodiments, the chassis 509 can have any number of cylindrical housings as dictated by design requirements. Each cylindrical housing 516, 518 can accommodate at least one motor. For example, a first motor 511 is positioned within a first housing 516 and a second motor 522 is positioned within a second housing 518. According to exemplary embodiments, the first and second motors 511, 522 of the orbit actuator 500 are positioned concentrically atop one another. In a typical embodiment, the first and second motors 511, 522 are hollow shaft motors enabling various items such as, for example, cables, hosing, piping, or other component to pass through the motors without obstruction.

In a typical embodiment, the spherical joint 506 is made of an upper hemisphere 512 and a lower hemisphere 513. For example, the upper hemisphere 512 forms an upper half of the spherical joint 506 while the lower hemisphere 513 forms the lower half of spherical joint 506. In a typical embodiment, the spherical joint 506 is configured to perform a wide range of movements in multiple directions. The design of the exemplary orbit actuator 500 addresses several issues commonly found in traditional multi-axis systems. For example, by combining a plurality of axes of motion into a single joint, the spherical joint 506 reduces bulkiness typically associated with traditional multi-axis systems. In a typical embodiment, the spherical joint 506 combines at least two axes of motion into a single joint. In a typical embodiment, the first motor 511 rotates the lower hemisphere 513 about Axis 1. The second motor 522 rotates the upper hemisphere 512 about Axis 2 and moves with the lower hemisphere 513 as the lower hemisphere 513 rotates around Axis 1. Axis 1 is an axis that lies along a longitudinal axis of the exemplary actuator 500. Axis 2 lies at approximately a 45° angle relative to Axis 1. The through-hole 502 nests within the chassis 509, the upper hemisphere 512, and the lower hemisphere 513 and serves the dual purpose of providing optimal wire routing through the orbit actuator 500 and connecting the upper hemisphere 512 and the lower hemisphere 513 together. The embodiment illustrated in FIG. 5A is useful in applications where 3 DOF motion is not necessary.

FIG. 5B is a partially sectioned side view illustrating internal components of an alternate embodiment of the orbit actuator 550. For illustrative purposes, FIG. 5B will be described herein relative to FIG. 5A. The orbit actuator 550 illustrated in FIG. 5B is similar to the orbit actuator 500 of FIG. 5A with the exception that the orbit actuator 550 further includes an end effector 503. The end effector 503 serves as a functional tip of the orbit actuator 550. The end effector 503 may be attached to an end of the orbit actuator 550 and may interact with the environment. The end effector 503 may be of various types depending on the desired task of the orbit actuator 550. For example, the end effector 503 may be, for example, a gripper, a cutting tool, a welding torch, a sensor, a vacuum gripper, or any other specialized tool for the desired task of the orbit actuator 550.

The chassis 509 includes the plurality of cylindrical housings 516, 518 stacked concentrically atop one other. For illustrative purposes, the chassis 509 is illustrated as having the two cylindrical housings 516, 518; however, in other embodiments, the chassis 509 can have any number of cylindrical housings as dictated by design requirements. Each cylindrical housing 516, 518 can accommodate at least one motor. For example, the first motor 511 is positioned within the first housing 516 and the second motor 522 is positioned within the second housing 518. According to exemplary embodiments, the first and second motors 511, 522 of the orbit actuator 550 are positioned concentrically atop one another. In a typical embodiment, the first and second motors 511, 522 are hollow shaft motors enabling various items such as, for example, cables, hosing, piping, or other component to pass through the motors without obstruction.

In a typical embodiment, the lower hemisphere 513 remains fixed to the chassis 509. The first motor 511 rotates the upper hemisphere 512 about Axis 2 while the second motor 522 rotates the end-effector about Axis 3. Axis 1 is an axis that lies along a longitudinal axis of the exemplary actuator 550. Axis 2 lies at approximately a 45° degree angle against Axis 1 and remains fixed to the static lower hemisphere 513. Axis 3 lies at approximately a 45° degree angle relative to Axis 2. The through-hole 502 nests within the chassis 509 and the spherical joint 506 and serves the dual purpose of providing optimal wire routing through the orbit actuator 550 and connecting the upper hemisphere 512 and the lower hemisphere 513 together. The embodiment illustrated in FIG. 5B is useful in applications where 3 DOF motion is already present.

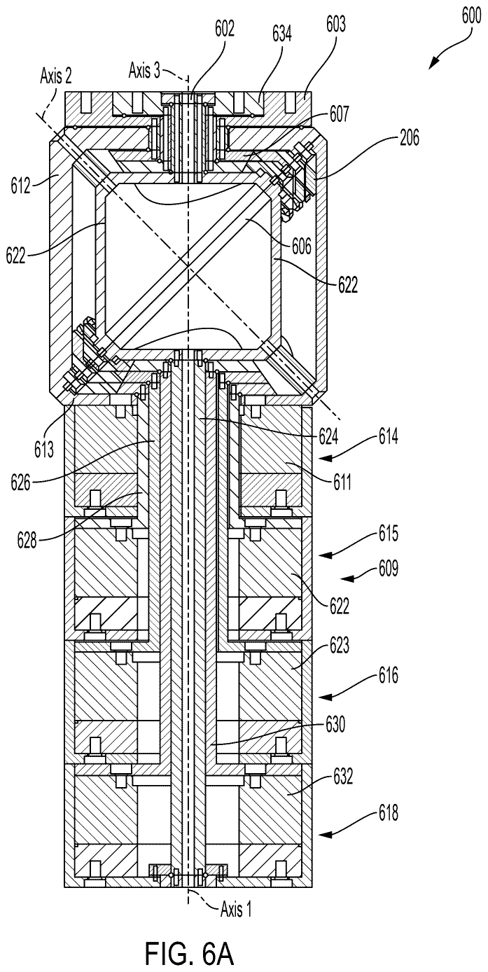

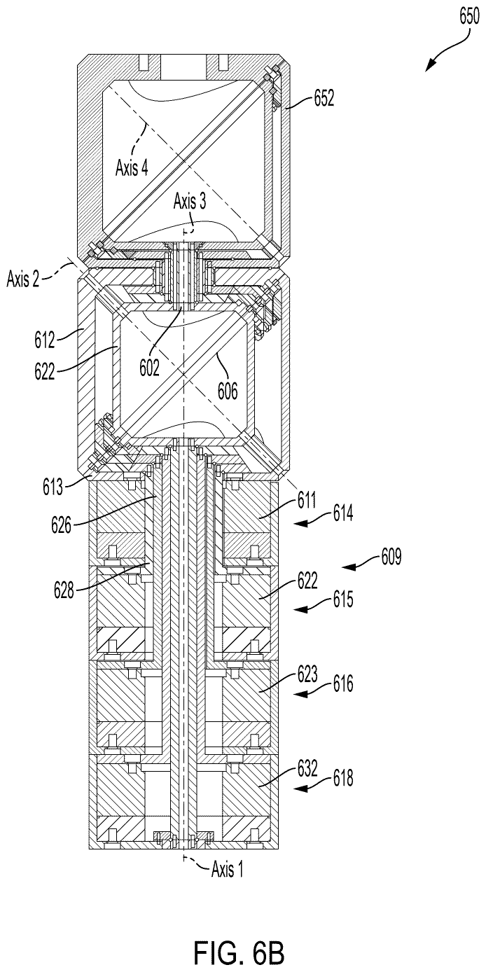

FIG. 6A is a partially sectioned side view illustrating internal components of an alternate orbit actuator 600. For illustrative purposes, FIG. 6A will be described herein relative to FIGS. 1A-5B. In a typical embodiment, the orbit actuator 600 includes various components that allow the orbit actuator 600 to achieve multi-axis motion. In a typical embodiment, the orbit actuator 600 includes at least one end effector 603, an end effector gear 607, an upper hemisphere 612, and a lower hemisphere 613. The orbit actuator 600 further includes a plurality of hollow-thrust-bearing-nuts 660, a plurality of shafts and a plurality of motors. In a typical embodiment, the plurality of shafts includes a first shaft 624, a second shaft 626, a third shaft 628, and a fourth shaft 630 while the plurality of motors includes a first motor 611, a second motor 622, a third motor 623, and a fourth motor 632. For illustrative purposes, the orbit actuator 600 is described as having four shafts and four motors; however, in other embodiments, any number of shafts and motors may be used to operate the orbit actuator 600 as dictated by design requirements.

The first motor 611, the second motor 622, the third motor 623, and the fourth motor 632 are positioned within a chassis 609. The chassis 609 includes a plurality of cylindrical housings 614, 615, 616, 618 stacked concentrically atop one other. Each cylindrical housing 614, 615, 616, 618 can accommodate at least one motor. For example, in the embodiment illustrated in FIG. 6A, the first motor 611 is positioned within the first housing 614, the second motor 622 is positioned within the second housing 615, the third motor 623 is positioned within the third housing 616, and the fourth motor 632 is positioned within the fourth housing 618.

In a typical embodiment, the spherical joint 606 is made of the upper hemisphere 612 and the lower hemisphere 613. For example, the upper hemisphere 612 forms an upper half of the spherical joint 606 while the lower hemisphere 613 forms the lower half of spherical joint 606. In a typical embodiment, each of the upper hemisphere 612 and the lower hemisphere 613 lies concentrically within the same spherical plane. The various components of the orbit actuator 600 disclosed above are part of a kinetic chain that corresponds to an axis of motion of the orbit actuator 600 similar to the kinetic chains (e.g., the first, second, and third kinetic chains) described above relative to FIGS. 2A-2B with the exception that the orbit actuator 600 is capable of providing an additional degree of motion in the spherical joint 606. This is achieved through a fourth kinetic chain nested within the three kinetic chains (e.g., the first, second, and third kinetic chains) described above relative to FIGS. 2A-2B. For example, the fourth kinetic chain includes the fourth shaft 630 and the fourth motor 632. The fourth motor 632 may be operatively connected to a second end effector 634 via the fourth shaft 630. The second end effector 634 sits concentric and flush to the at least one end effector 603. The embodiment illustrated in FIG. 6A is particularly useful in applications where an additional DOF motion is needed to actuate some secondary mechanism such as, for example, a gripper or the like without needing to add weight of an additional motor to the top of the end effector 603 or 634.

In some embodiments, the orbit actuator 600 may include only three axes similar to the orbital actuator 100. Similar to orbit actuator 100, the three axes version omits a cylindrical housings 618, one of the double-sided ring gears 206 and associated gear mechanisms for the fourth shaft, the second end effector 634, and the fourth shaft 630, similar to the two axis version shown in FIG. 5B which omits two of each component rather than one. The orbit actuator 600 can also be increased by adding additional housings, ring gears, shafts, and end effectors to increase the number of axes to five, six, seven, or more axes.

FIG. 6B is a partially sectioned side view illustrating internal components of an alternate orbit actuator 650. For illustrative purposes, FIG. 6B will be described herein relative to 1A-6A. The orbit actuator 650 is similar to the orbit actuator 600 of FIG. 6A with a few exceptions. For example, in place of the two end effectors present in the embodiment of FIG. 6A, additional components may be added to at least two kinetic chains enabling creation of a second spherical joint 652 atop the first spherical joint 606. This embodiment is useful in applications where a range of motion similar to a robotic arm is required in, for example, Computer Numerical Control (CNC) machining, biomimetic scapular-shoulder joints for humanoids, or the like.

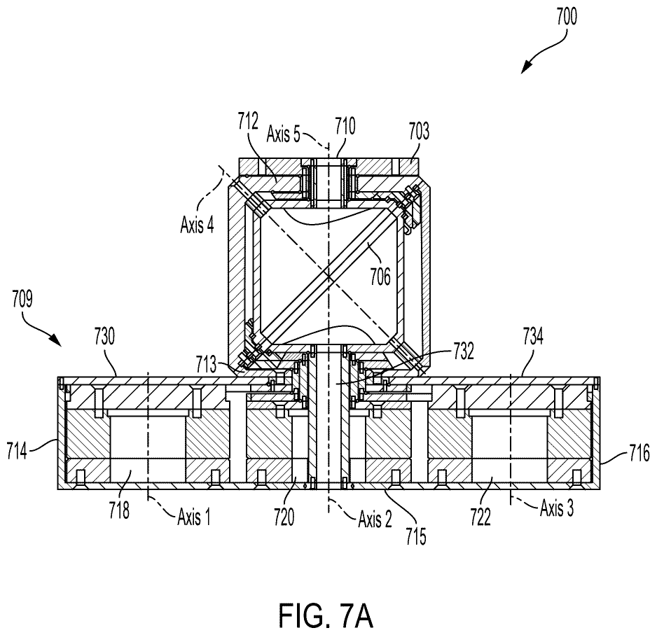

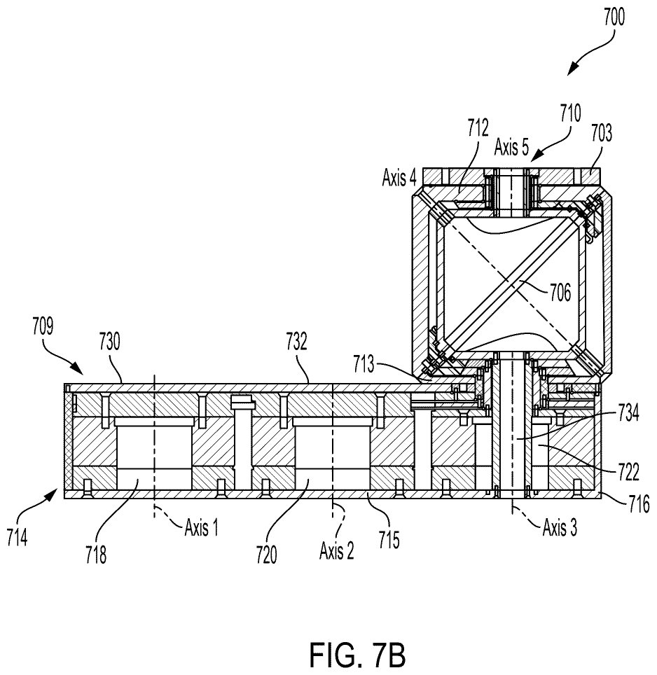

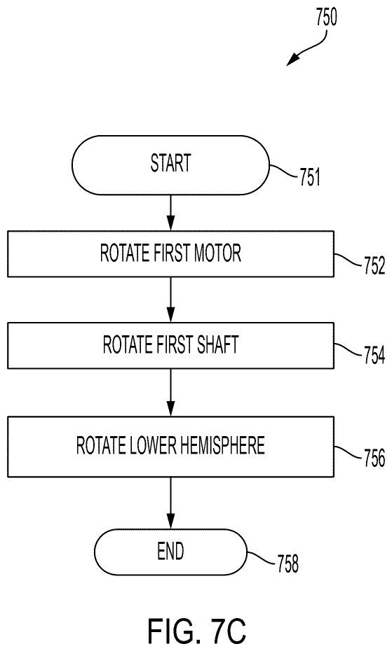

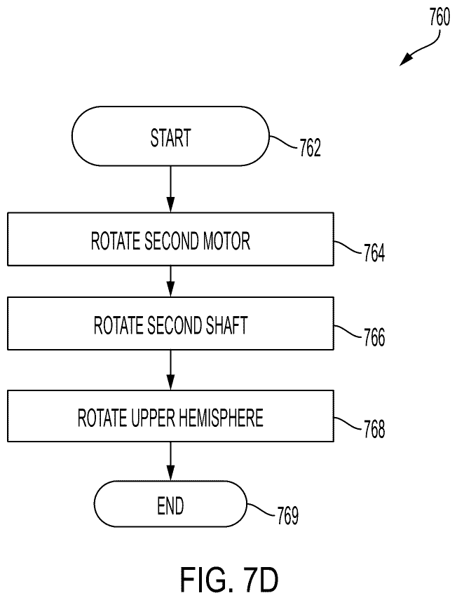

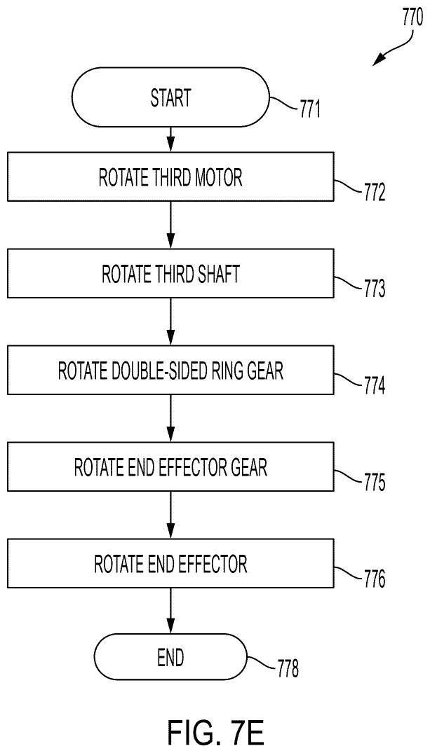

FIG. 7A is a partially sectioned side view illustrating a side perspective view of an alternate embodiment of an orbit actuator 700. FIG. 7B is a side perspective view of an alternate embodiment of an orbit actuator 700. For illustrative purposes, FIGS. 7A-7B will be described herein relative to 1A-6B. In a typical embodiment, the orbit actuator 700 includes an end effector 703, a spherical joint 706, a chassis 709, and a through-aperture 710. The end effector 703 serves as a functional tip of the orbit actuator 700. The end effector 703 may be attached to an end of the orbit actuator 700 and may interact with the environment. The end effector 703 may be of various types depending on the desired task of the orbit actuator 700. For example, the end effector 703 may be, for example, a gripper, a cutting tool, a welding torch, a sensor, a vacuum gripper, or any other specialized tool for the desired task of the orbit actuator 700.

In a typical embodiment, the end effector 703 may be attached to the spherical joint 706. The spherical joint 706 may be positioned between the end effector 703 and the chassis 709. The spherical joint 706 enables the orbital actuator 100 to perform precise and complex motion, providing a compact and efficient resource of achieving 3 DOF motion. In a typical embodiment, the spherical joint 706 is configured to mimic a natural motion of, for example, a ball-and-socket joint, similar to a human shoulder, enabling the spherical joint 706 to perform a wide range of movements in multiple directions. In a typical embodiment, the spherical joint 106 combines at least three axes of motion into a single joint. The spherical joint 706 is configured to simplify the mathematical and control complexities involved in multi-axis motion.

In a typical embodiment, the at least three axes of motion can be achieved via an upper hemisphere 712, a lower hemisphere 713, and the end effector 703. The lower hemisphere 713 is configured to rotate within a first plane and provide a first axis of motion (e.g., Axis 1, Axis 2, Axis 3). The upper hemisphere 712 is configured to rotate within a second plane and provide a second axis of motion. The end effector 103 provides a third axis of motion. In a typical embodiment, the lower hemisphere 713 rotates around either Axis 1, Axis 2, or Axis 3 depending on the positioning of the spherical joint 706 while the upper hemisphere 712 rotates around Axis 4. Axis 4 is an axis that lies at approximately a 45° angle relative to Axis 1, Axis 2, or Axis 3. The end effector 103 rotates around Axis 5. Axis 5 is an axis that lies at approximately a 45° angle relative to axis 4.

The chassis 709 may be attached to the spherical joint 706 opposite the end effector 703. In a typical embodiment, the chassis 709 includes a first cylindrical housing 714, a second cylindrical housing 715 and a third cylindrical housing 716 positioned parallel to one another. For illustrative purposes, the chassis 709 is illustrated as having three cylindrical housings such as, for example, a first housing 714, a second housing 715 and a third housing 716 positioned parallel to one another; however, in other embodiments, the chassis 709 can have any number of cylindrical housings positioned parallel to one another as dictated by design requirements. The chassis 709 also includes a first cavity 730, a second cavity 732, and a third cavity 734. Each of the first, second and third cylindrical housings 714, 715, 716 may include, for example, a hollow shaft motor 718, 720, 722, respectively. The hollow shaft motor may be a type of electric motor that features a hollow center through its axis. This design enables various items such as, for example, cables, hosing, piping, or other component to pass through the motors without obstruction. In the embodiment illustrated in FIG. 7A, the spherical joint 706 is positioned between the end effector 703 and the second cylindrical housing 715 of the chassis 709 such that the through-aperture 710 aligns with the second cavity 732 facilitating the integration of the orbit actuator 700 with other mechanical or electrical systems and allowing, for example, wires, cable, tubing, or the like to route through the entire orbit actuator 700 without impeding the orbit actuator's 700 multi-axis motion.

The orbit actuator 700 illustrated in FIG. 7B is similar to the orbit actuator 700 of FIG. 7A with the exception that the spherical joint 706 is positioned between the end effector 703 and the third cylindrical housing 716 of the chassis 709 such that the through-aperture 710 aligns with the third cavity 734 facilitating the integration of the orbit actuator 700 with other mechanical or electrical systems and allowing, for example, wires, cable, tubing, or the like to route through the entire orbit actuator 700 without impeding the orbit actuator's 700 multi-axis motion. For illustrative purposes, the spherical joint 706 is illustrated as being positioned between the end effector 703 the second cylindrical housing 715 and the third cylindrical housing 716 in FIGS. 7A-7B; however, in other embodiments, the spherical joint 706 may be positioned between the end effector 703 and any one of the first cylindrical housing 714, the second cylindrical housing 715, and the third cylindrical housing 716. In the embodiments illustrated in FIGS. 7A-7B, the motion of the plurality of motors 718, 720, 722 is transmitted to the spherical joint 706 via for example, belts, gears or the like. The arrangement illustrated in FIGS. 7A-7B is useful in applications where space is limited and positioning of the spherical joint 706 on the actuator 700 is critical.

FIG. 7C is a flow diagram of an illustrative process 750 for rotating the orbit actuator 100 within a first axis of motion. For illustrative purposes, FIG. 7C will be described herein relative to 1A-2B. The process 750 begins at step 751. In a typical embodiment, the process 750 can be performed by the components in the first kinetic chain such as, for example, the first shaft 210, the first motor 211, and the lower hemisphere 113. At step 752, the first motor 211 is rotated. In a typical embodiment, the first motor 211 is positioned within the chassis 109 of the orbit actuator 100 and can initiate the motion of the first kinetic chain. The first motor 211 may be, for example, a hollow shaft motor, which allows for the passage of cables and other components through its center, facilitating better cable management and integration with other systems.

At step 754, the first shaft 210 is rotated. For example, when the first motor 211 is activated, the first motor 211 generates rotational motion that is transmitted to the first shaft 210. The first shaft 210 can be directly connected to the lower hemisphere 213 of the spherical joint 106. At step 756, the lower hemisphere 113 is rotated. In a typical embodiment, as the first motor 211 rotates, the first motor 211 drives the first shaft 210, which in turn causes the lower hemisphere 113 to rotate Axis 1. The process 750 ends at step 758.

FIG. 7D is a flow diagram of an illustrative process 760 for rotating the orbit actuator 100 within a second axis of motion. For illustrative purposes, FIG. 7D will be described herein relative to 1A-2B. The process 760 begins at step 762. In a typical embodiment, the process 760 can be performed by the components in the second kinetic chain such as, for example, the second shaft 220, the second motor 222, and the upper hemisphere 112. At step 764, the second motor 222 is rotated. In a typical embodiment, the second motor 222 is positioned within the chassis 109 of the orbit actuator 100 and can initiate the motion of the second kinetic chain. The second motor 222 may be, for example, a hollow shaft motor, which allows for the passage of cables and other components through its center, facilitating better cable management and integration with other systems.

At step 766, the second shaft 220 is rotated. For example, when the second motor 222 is activated, the second motor 222 generates rotational motion that is transmitted to the second shaft 220. The second shaft 220 is directly connected to the upper hemisphere 112 of the spherical joint 106 and can function as, for example, a pinion. At step 768, the upper hemisphere 112 is rotated. In a typical embodiment, as the second motor 222 rotates, the second motor 222 drives the second shaft 220, which in turn causes the upper hemisphere 112 to rotate around the Axis 2. The process 760 ends at step 769.

FIG. 7E is a flow diagram of an illustrative process 770 for rotating the orbit actuator 100 within a third axis of motion. For illustrative purposes, FIG. 7E will be described herein relative to 1A-2B. The process 770 begins at step 772. In a typical embodiment, the process 770 can be performed by the components in the third kinetic chain such as, for example, the third shaft 230, the third motor 223, the end effector gear 204, the double-sided ring gear 206, and the end effector 103. At step 772, the third motor 223 is rotated. In a typical embodiment, the third motor 223 is positioned within the chassis 109 of the orbit actuator 100 and can initiate the motion of the third kinetic chain. The third motor 223 may be, for example, a hollow shaft motor, which allows for the passage of cables and other components through its center, facilitating better cable management and integration with other systems.

At step 773, the third shaft 230 is rotated. For example, when the third motor 223 is activated, the third motor 223 generates rotational motion that is transmitted to the third shaft 230. In a typical embodiment, the third shaft 230 acts as a pinion and is connected to the double-sided ring gear 206 inside the spherical joint 106. At step 774, the double-sided ring gear 206 is rotated. For example, when the third motor 223 is activated, the third motor 223 generates rotational motion that is transmitted to the third shaft 230 which in turn causes the double-sided ring gear 206 to rotate. In a typical embodiment, the double-sided ring gear 206 includes teeth on both its inner and outer surfaces. This design allows the double-sided ring gear 206 to interact with multiple pinions simultaneously, enabling efficient power transmission and control.

At step 775, the end effector 103 is rotated. In a typical embodiment, the outer teeth of the double-sided ring gear 206 engages with the end effector gear 204 and as the double-sided ring gear 206 rotates, the double-sided ring gear 206 transmits rotational motion to the end effector gear 204. In a typical embodiment, the end effector 103 may be connected to the end effector gear 204, which can be driven by the double-sided ring 206. This connection enables the rotational motion generated by the third motor 223 to be transmitted to the end effector 103. As the end effector gear 204 rotates, the gear 204 can transmit rotational motion to the end effector 103 causing the end effector to rotate around Axis 3 (step 776). At step 778, the process 770 ends.

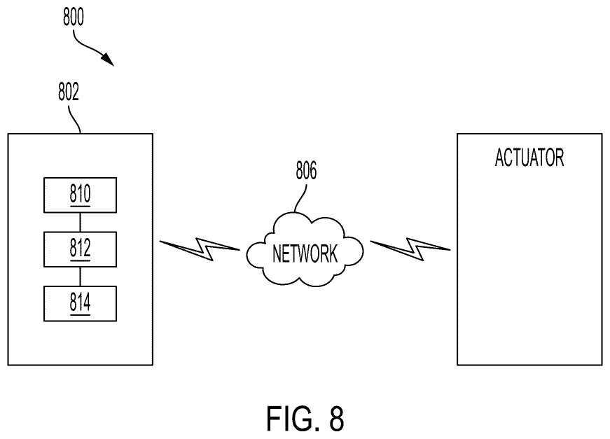

FIG. 8 illustrates a computing environment for controlling the orbit actuators disclosed above in FIGS. 1A-7B. For illustrative purposes, FIG. 8 will be described herein relative to 1A-7B. The disclosure herein can be carried out wholly or in part by a computing environment 800, which can include at least one computing device 802. For illustrative purposes, only one computing device 802 is illustrated; however, in other embodiments, a plurality of computing devices may be utilized and arranged, for example, in one or more server banks or computer banks or other arrangements. Such computing devices can be located in a single installation or may be distributed among many different geographical locations. In various embodiments, the at least one computing device 802 may include mobile computing devices such as, for example, smart phones, tablet computers, wearable technology, laptop computers, desktop computers, or the like. In general, the at least one computing device 802 may be any computing device (with or without a display) that is capable of transmitting and receiving electronic communications via a network 806. In certain examples, the network 806 may be a wired network or a wireless network such as, for example, a cellular network, a local network, or the like.

The at least one computing device 802 can send signals to various components of the exemplary orbit actuators described above in FIGS. 1A-7B. For example, the at least one computing device 802 can send signals to at least one of the plurality of motors such as, for example, the plurality of motors described above in FIGS. 1A-7B to achieve the desired multi-axis motion. The at least one computing device 802 can include a processor 810, a memory 812, and communication interfaces 814 that enable the at least one computing device 802 to execute control algorithms and communicate with the plurality of motors described above in FIGS. 1A-7B. The computing device can generate control signals based on the desired motion parameters. These signals can be transmitted to the plurality of motors via communication interfaces such as wired connections (e.g., Ethernet, CAN bus) or wireless protocols (e.g., Wi-Fi, Bluetooth).

Each motor of the plurality of motor described above in FIGS. 1A-7B can be equipped with a motor driver that can receive the control signals from the at least one computing device 802. The motor driver can convert these signals into electrical power that can drive the plurality of motors described above in FIGS. 1A-7B. For example, the at least one computing device 802 can send signals to the first motor 211 in order to rotate the lower hemisphere 113 around the first axis of motion (Axis 1). The at least one computing device 802 can send signals to the second motor 222 in order to rotate the upper hemisphere 112 around the second axis of motion (Axis 2). The at least one computing device 802 can send signals to the third motor 223 in order to rotate the end effector 103 around the third axis of motion (Axis 3).

In some embodiments, the at least one computing device 802 can determine a desired position of each of the plurality of motors described above in FIGS. 1A-7B and calculate pathing to move from a current position to the desired position. The computing device can send signals to cause the plurality of motors described above in FIGS. 1A-7B to move simultaneously to the desired position. The pathing can include speeds for moving to comply with various constraints, such as to prevent jerky movements or to avoid contact with objects in the environment. The orbit actuators described above in FIGS. 1A-7B can include sensors that provide real-time feedback on the position, speed, orientation, and load of the motors. The feedback can be sent back to the at least one computing device 802, which can process the data to adjust the control signals dynamically, facilitating precise and accurate motion of the orbit actuators described above in FIGS. 1A-7B. The at least one computing device 802 can execute advanced control algorithms such as Proportional-Integral-Derivative (PID) control, to manage the motion of the orbit actuators described above in FIGS. 1A-7B. These algorithms can calculate the necessary adjustments to the motor signals to achieve smooth and coordinated multi-axis motion. The at least one computing device 802 can calculate the kinematics of the orbit actuators described above in FIGS. 1A-7B and generate synchronized control signals that drive the motors described above in FIGS. 1A-7B. The at least one computing device 802 can monitor the operation of the orbit actuators described above in FIGS. 1A-7B for any anomalies or errors. In case of a detected issue, such as a motor overload or unexpected motion, the at least one computing device 802 can initiate safety protocols to stop the motors and prevent damage to the system. By integrating these control mechanisms, the at least one computing device 802 can enable the orbit actuators described above in FIGS. 1A-7B to operate efficiently, accurately, and safely, providing reliable multi-axis motion for various applications.

Aspects, features, and benefits of the systems, methods, processes, formulations, apparatuses, and products discussed herein will become apparent from the information disclosed in the exhibits and the other applications as incorporated by reference. Variations and modifications to the disclosed systems and methods may be affected without departing from the spirit and scope of the novel concepts of the disclosure. Any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device, or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

Clause 1. An actuator comprising: at least one end effector; a chassis; a spherical joint positioned between the at least one end effector and the chassis; and wherein the spherical joint comprises an upper hemisphere that forms an upper half of the spherical joint and a lower hemisphere that forms a lower half of the spherical joint, wherein the upper hemisphere and the lower hemisphere lie concentrically within a common spherical plane.

Clause 2. The actuator of clause 1 or any other clause herein further comprising: a through-aperture; and wherein the through-aperture comprises a cavity that runs along a center of the at least one end effector, the chassis and the spherical joint allowing wires to route through the actuator without impeding multi-axis motion of the actuator.

Clause 3. The actuator of clause 1 or any other clause herein further comprising: a plurality of motors positioned within the chassis, wherein the plurality of motors comprise: a first motor positioned within a first housing of the chassis; a second motor positioned within a second housing of the chassis; and a third motor positioned within a third housing of the chassis.

Clause 4. The actuator of clause 3 or any other clause herein, wherein: the first housing, the second housing and the third housing are positioned concentrically atop one another; and the first motor, the second motor and the third motor are positioned concentrically atop one another.

Clause 5. The actuator of clause 4 or any other clause herein, wherein: the first motor is operatively coupled to the lower hemisphere via a first shaft; the second motor is operatively coupled to the upper hemisphere via a second shaft; and the third motor is operatively coupled to the at least one end effector via a third shaft.

Clause 6. The actuator of clause 5 or any other clause herein, wherein: upon activation of the first motor, the lower hemisphere rotates around a first axis; upon activation of the second motor, the upper hemisphere rotates around a second axis; and upon activation of the third motor, the at least one end effector rotates around a third axis.

Clause 7. The actuator of clause 6 or any other clause herein, wherein: the first axis lies along a longitudinal axis of the actuator; the second axis lies at approximately a 45°degree angle relative to the first axis; and the third axis lies at approximately a 45°degree angle relative to the second axis.

Clause 8. The actuator of clause 6 or any other clause herein, wherein: the first axis lies along a longitudinal axis of the actuator; the second axis lies at approximately a 60° degree angle relative to the first axis; and the third axis lies at approximately a 60°degree angle relative to the second axis.

Clause 9. The actuator of clause 1 or any other clause herein further comprising: a plurality of motors positioned within the chassis, wherein the plurality of motors comprise: a first motor positioned within a first housing of the chassis; and a second motor positioned within a second housing of the chassis.

Clause 10. The actuator of clause 9 or any other clause herein, wherein: the first housing and the second housing are positioned concentrically atop one another; and the first motor and the second motor are positioned concentrically atop one another.

Clause 11. The actuator of clause 10 or any other clause herein, wherein: the first motor is operatively coupled to the lower hemisphere via a first shaft; upon activation of the first motor, the lower hemisphere rotates around a first axis; the second motor is operatively coupled to the upper hemisphere via a second shaft; and upon activation of the second motor, the upper hemisphere rotates around a second axis.

Clause 12. The actuator of clause 11 or any other clause herein, wherein: the first axis lies along a longitudinal axis of the actuator; and the second axis lies at approximately a 45° degree angle relative to the first axis.

Clause 13. The actuator of clause 1 or any other clause herein further comprising: a plurality of motors positioned within the chassis, wherein the plurality of motors comprise: a first motor positioned within a first housing of the chassis; a second motor positioned within a second housing of the chassis; a third motor positioned within a third housing of the chassis; and a fourth motor positioned within a fourth housing of the chassis.

Clause 14. The actuator of clause 13 or any other clause herein, wherein: the first housing, the second housing, the third housing and the fourth housing are positioned concentrically atop one another; and the first motor, the second motor, the third motor and the fourth motor are positioned concentrically atop one another.

Clause 15. The actuator of clause 14 or any other clause herein, wherein: the first motor is operatively coupled to the lower hemisphere via a first shaft; the second motor is operatively coupled to the upper hemisphere via a second shaft; the third motor is operatively coupled to a first end effector of the at least one end effector via a third shaft; and the fourth motor is operatively coupled to a second end effector of the at least one end effector via a fourth shaft.

Clause 16. The actuator of clause 15 or any other clause herein, wherein: the lower hemisphere is rotated upon activation of the first motor; the upper hemisphere is rotated upon activation of the second motor; the first end effector is rotated upon activation of the third motor; and the second end effector is rotated upon activation of the fourth motor.

Clause 17. The actuator of clause 1 or any other clause herein further comprising: a plurality of motors positioned within the chassis, wherein the plurality of motors comprise: a first motor positioned within a first housing of the chassis; a second motor positioned within a second housing of the chassis; a third motor positioned within a third housing of the chassis; and wherein the first housing, the second housing and the third housing are positioned parallel to one another.

Clause 18. The actuator of clause 1 or any other clause herein, wherein the spherical joint combines at least three axes of motion into a single joint.

Clause 19. An actuator comprising: at least one end effector; a chassis; a spherical joint positioned between the at least one end effector and the chassis, wherein the spherical joint enables the actuator to perform multi-axis motion; and a through-aperture comprising a cavity that runs along a center of the at least one end effector, the chassis and the spherical joint allowing wires to route through the actuator without impeding the multi-axis motion of the actuator.

Clause 20. An actuator comprising: at least one end effector; a chassis; a spherical joint positioned between the at least one end effector and the chassis, wherein the spherical joint comprises an upper hemisphere that forms an upper half of the spherical joint and a lower hemisphere that forms a lower half of the spherical joint, wherein the upper hemisphere and the lower hemisphere lie concentrically within a common spherical plane; a plurality of motors positioned within the chassis, wherein the plurality of motors are positioned concentrically atop one another; and upon activation of at least one of the plurality of motors, at least one of the upper hemisphere, the lower hemisphere and the at least one end effector rotates enabling multi-axis motion of the actuator.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. An actuator comprising:
at least one end effector;
a chassis;
a spherical joint positioned between the at least one end effector and the chassis; and
wherein the spherical joint comprises an upper hemisphere that forms an upper half of the spherical joint and a lower hemisphere that forms a lower half of the spherical joint, wherein the upper hemisphere and the lower hemisphere lie concentrically within a common spherical plane.

2. The actuator of claim 1 further comprising:
a through-aperture; and
wherein the through-aperture comprises a cavity that runs along a center of the at least one end effector, the chassis and the spherical joint allowing wires to route through the actuator without impeding multi-axis motion of the actuator.

3. The actuator of claim 1 further comprising:
a plurality of motors positioned within the chassis, wherein the plurality of motors comprise:
a first motor positioned within a first housing of the chassis;
a second motor positioned within a second housing of the chassis; and
a third motor positioned within a third housing of the chassis.

4. The actuator of claim 3, wherein:
the first housing, the second housing and the third housing are positioned concentrically atop one another; and
the first motor, the second motor and the third motor are positioned concentrically atop one another.

5. The actuator of claim 4, wherein:
the first motor is operatively coupled to the lower hemisphere via a first shaft;
the second motor is operatively coupled to the upper hemisphere via a second shaft; and
the third motor is operatively coupled to the at least one end effector via a third shaft.

6. The actuator of claim 5, wherein:
upon activation of the first motor, the lower hemisphere rotates around a first axis;
upon activation of the second motor, the upper hemisphere rotates around a second axis; and
upon activation of the third motor, the at least one end effector rotates around a third axis.

7. The actuator of claim 6, wherein:
the first axis lies along a longitudinal axis of the actuator;
the second axis lies at approximately a 45° degree angle relative to the first axis; and
the third axis lies at approximately a 45° degree angle relative to the second axis.

8. The actuator of claim 6, wherein:
the first axis lies along a longitudinal axis of the actuator;
the second axis lies at approximately a 60° degree angle relative to the first axis; and
the third axis lies at approximately a 60° degree angle relative to the second axis.

9. The actuator of claim 1 further comprising:
a plurality of motors positioned within the chassis, wherein the plurality of motors comprise:
a first motor positioned within a first housing of the chassis; and
a second motor positioned within a second housing of the chassis.

10. The actuator of claim 9, wherein:
the first housing and the second housing are positioned concentrically atop one another; and
the first motor and the second motor are positioned concentrically atop one another.

11. The actuator of claim 10, wherein:
the first motor is operatively coupled to the lower hemisphere via a first shaft;
upon activation of the first motor, the lower hemisphere rotates around a first axis;
the second motor is operatively coupled to the upper hemisphere via a second shaft; and
upon activation of the second motor, the upper hemisphere rotates around a second axis.

12. The actuator of claim 11, wherein:
the first axis lies along a longitudinal axis of the actuator; and
the second axis lies at approximately a 45° degree angle relative to the first axis.

13. The actuator of claim 1 further comprising:
a plurality of motors positioned within the chassis, wherein the plurality of motors comprise:
a first motor positioned within a first housing of the chassis;
a second motor positioned within a second housing of the chassis;
a third motor positioned within a third housing of the chassis; and
a fourth motor positioned within a fourth housing of the chassis.

14. The actuator of claim 13, wherein:
the first housing, the second housing, the third housing and the fourth housing are positioned concentrically atop one another; and
the first motor, the second motor, the third motor and the fourth motor are positioned concentrically atop one another.

15. The actuator of claim 14, wherein:
the first motor is operatively coupled to the lower hemisphere via a first shaft;
the second motor is operatively coupled to the upper hemisphere via a second shaft;
the third motor is operatively coupled to a first end effector of the at least one end effector via a third shaft; and
the fourth motor is operatively coupled to a second end effector of the at least one end effector via a fourth shaft.

16. The actuator of claim 15, wherein:
the lower hemisphere is rotated upon activation of the first motor;
the upper hemisphere is rotated upon activation of the second motor;
the first end effector is rotated upon activation of the third motor; and
the second end effector is rotated upon activation of the fourth motor.

17. The actuator of claim 1 further comprising:
a plurality of motors positioned within the chassis, wherein the plurality of motors comprise:
a first motor positioned within a first housing of the chassis;
a second motor positioned within a second housing of the chassis;
a third motor positioned within a third housing of the chassis; and
wherein the first housing, the second housing and the third housing are positioned parallel to one another.

18. The actuator of claim 1, wherein the spherical joint combines at least three axes of motion into a single joint.

19. An actuator comprising:
at least one end effector;
a chassis;
a spherical joint positioned between the at least one end effector and the chassis, wherein the spherical joint enables the actuator to perform multi-axis motion; and
a through-aperture comprising a cavity that runs along a center of the at least one end effector, the chassis and the spherical joint allowing wires to route through the actuator without impeding the multi-axis motion of the actuator.

20. An actuator comprising:
at least one end effector;
a chassis;
a spherical joint positioned between the at least one end effector and the chassis, wherein the spherical joint comprises an upper hemisphere that forms an upper half of the spherical joint and a lower hemisphere that forms a lower half of the spherical joint, wherein the upper hemisphere and the lower hemisphere lie concentrically within a common spherical plane;
a plurality of motors positioned within the chassis, wherein the plurality of motors are positioned concentrically atop one another; and
upon activation of at least one of the plurality of motors, at least one of the upper hemisphere, the lower hemisphere and the at least one end effector rotates enabling multi-axis motion of the actuator.
